(19) United States
(12) Patent Application Publication
(10) Pub. No.: US 2026/0356420 A1
(43) Pub. Date: Nov. 12, 2026

(54) Electric Power Steering Device

(71) Applicant: Hitachi Astemo, Ltd., Hitachinaka-shi, Ibaraki (JP)

(72) Inventor: Masatoshi ENOMOTO, Hitachinaka-shi, Ibaraki (JP)

(21) Appl. No.: 19/111,945

(22) PCT Filed: Sep. 6, 2023
(86) PCT No.: PCT/JP2023/032444

§ 371 Date: Mar. 14, 2025

(30) Foreign Application Priority Data
Sep. 15, 2022 (JP) 2022-146651

(51) Int. Cl. B62D 5/04; F16C 19/06; F16C 35/067

(52) U.S. Cl. CPC B62D 5/0403; B62D 5/0448; F16C 19/06; F16C 35/067

(57) ABSTRACT

An electric power steering device includes: a first housing accommodating a rack shaft; and a second housing accommodating a transmission mechanism for transmitting a steering assist force from an electric motor to the rack shaft. The first and second housings are arranged axially of the rack shaft and coupled with each other. A ball screw mechanism is disposed radially outside the rack shaft, and has a rotation part supported by a bearing rotatably with respect to the first housing. A holder holds the bearing between the holder and the first housing, and has an axial end face abutting on the second housing and facing away from the bearing. An elastic member is disposed between the bearing and the holder or the first housing axially of the rack shaft. The holder includes a portion radially outside the bearing, at which the holder is positioned with respect to the second housing.

### TECHNICAL FIELD

The present invention relates to an electric power steering device.

### BACKGROUND ART

For example, a patent document identified below discloses a known conventional electric power steering device.

In the electric power steering device according to the patent document, radially outside a rack bar, a rotation part (pulley) of a ball screw mechanism is supported rotatably with respect to a housing via a bearing, wherein the bearing is fastened to the housing via a lock nut that is screwed in the housing.

### PRIOR ART DOCUMENT(S)

### Patent Document(s)

Patent Document 1: JP 2018-039391 A

### SUMMARY OF INVENTION

### Problem(s) to be Solved by the Invention

However, the configuration of the conventional electric power steering device that the bearing is fastened to the housing by the lock nut may cause galling of the lock nut with respect to the housing. Furthermore, if the lock nut is made of a material different from that of the housing, the lock nut may be loosened due to heat. In view of the foregoing, there has been room for improvement.

The present invention has been made in view of the technical problems described above, wherein an electric power steering device is provided which is capable of continuously holding a bearing in a suitable manner.

### Means for Solving the Problem(s)

According to an embodiment of the present invention, a bearing is accommodated and supported inside a first housing, and is held by a holder whose axial movement is restricted by a second housing, wherein the second housing is arranged to face the first housing in an axial direction.

### Effect(s) of the Invention

According to the present invention, the bearing can be continuously held in a suitable manner.

### BRIEF DESCRIPTION OF DRAWINGS

FIG. 1 is a front view of a steering device according to the present invention.

FIG. 2 is a cross-sectional view of a transmission mechanism and its surroundings shown in FIG. 1.

FIG. 3 is an enlarged view of a major part of FIG. 2.

FIG. 4 is an enlarged view of a holder shown in FIG. 2.

### MODE(S) FOR CARRYING OUT INVENTION

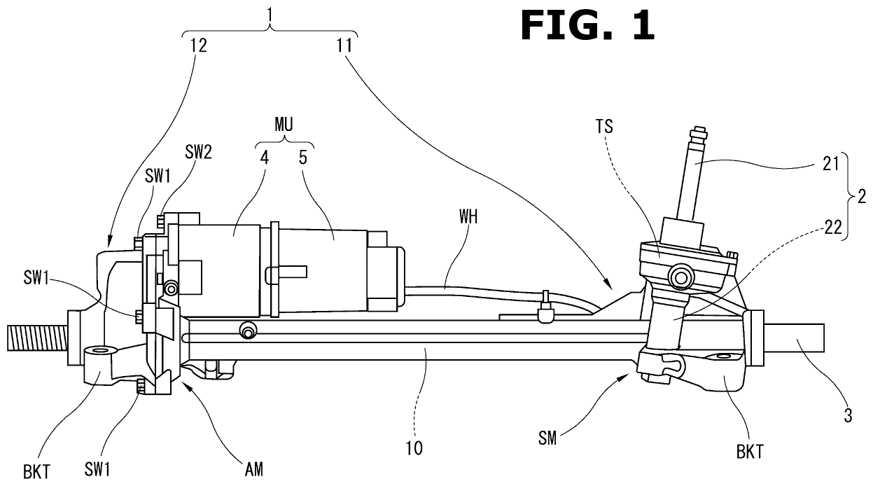

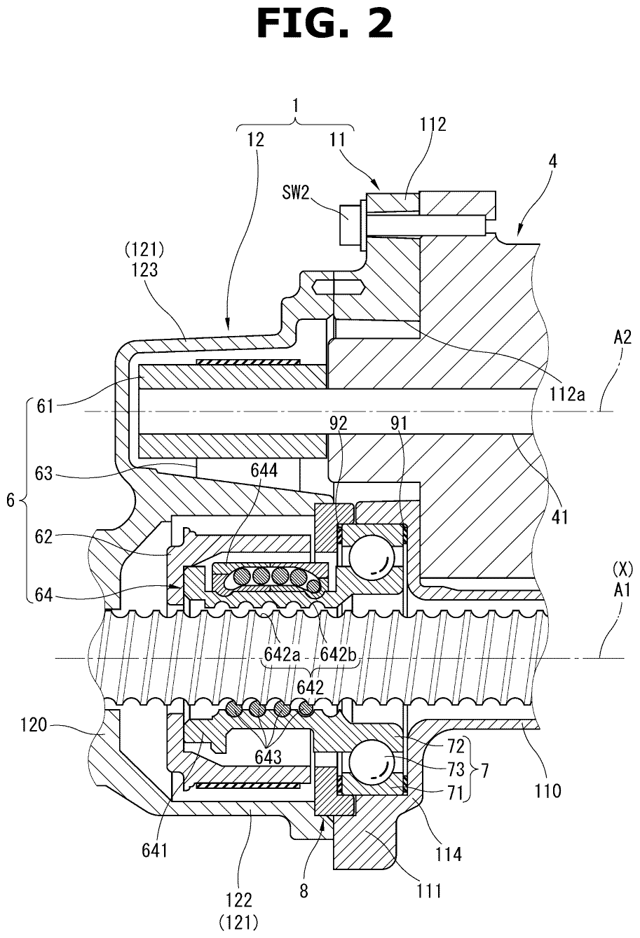

The following describes an electric power steering device according to an embodiment of the present invention in detail with reference to FIGS. 1 to 4. The electric power steering device is applied to a steering device of an automobile, similar to conventional examples. For convenience, FIGS. 1 to 4 are described wherein a direction along a central axis X of a rack bar 3 shown in FIG. 2 is referred to as “axial direction”, a direction perpendicular to the central axis X of the rack bar 3 is referred to as “radial direction”, and a direction around the central axis X of the rack bar 3 is referred to as “circumferential direction”.

<Configuration of Electric Power Steering Device>FIG. 1 is a front view of the electric power steering device according to the embodiment, showing an exterior of the electric power steering device.

As shown in FIG. 1, the electric power steering device includes: a steering mechanism SM for steering based on operation of a driver; and a steering assist mechanism AM for assisting steering operation of the driver. The electric power steering device is suspended from a body of the automobile via brackets BKT. The steering mechanism SM and the steering assist mechanism AM are accommodated in a first housing 11 and a second housing 12, respectively, each of which is provided with the bracket BKT.

The steering mechanism SM includes: a steering shaft 2 linked with a steering wheel not shown; and a rack bar 3 as a rack shaft linked with steerable wheels not shown. The steering shaft 2 and the rack bar 3 are linked with each other via a conversion mechanism not shown. The conversion mechanism is a so-called rack and pinion mechanism, which is composed of pinion teeth not shown and rack teeth not shown, wherein the steering shaft 2 (an output shaft 22 described below) is formed with the pinion teeth, and the rack bar 3 is formed with the rack teeth.

The steering shaft 2 is composed of: an input shaft 21 that rotates together with the steering wheel not shown as an integrated member; the output shaft 22 linked with the rack bar 3; and a torsion bar not shown connecting the input shaft 21 and the output shaft 22. The input shaft 21 has a first axial end side (an upper end side in FIG. 1) connected to the steering wheel not shown, and a second axial end side connected to the torsion bar not shown. The output shaft 22 has a first axial end side (an upper end side in FIG. 1) connected to the torsion bar not shown, and a second axial end side linked with the rack bar 3. Specifically, the second end side of the output shaft 22 has an outer periphery formed with the pinion teeth not shown that mesh with the rack teeth not shown of the rack bar 3. Thereby, rotation of the output shaft 22 can be transmitted to the rack bar 3, while being converted into axial movement of the rack bar 3. Furthermore, a torque sensor TS is arranged radially outside the steering shaft 2 to sense a steering torque that is inputted to the steering shaft 2 by a driver. The sensing of the steering torque by the torque sensor TS is based on an amount of relative rotation between the input shaft 21 and the output shaft 22.

The rack bar 3 has ends that are respectively linked with left and right steerable wheels not shown via tie rods not shown and knuckle arms not shown. Axial movement of the rack bar 3 causes the knuckle arms not shown to be pulled via the respective tie rods not shown, and thereby changes orientation of the steerable wheels not shown.

The rack bar 3 is accommodated in a rack bar accommodating section 10 and configured to move in the axial direction with its both ends exposed to the outside. The rack bar accommodating section 10 is formed inside the rack housing 1 having a substantially cylindrical shape. The rack housing 1 is composed of the first housing 11 and the second housing 12 which are formed by casting separately in the axial direction, wherein the first housing 11 houses a first axial end side of the rack bar 3, and the second housing 12 houses a second axial end side of the rack bar 3. The first housing 11 and the second housing 12 are fastened together by a plurality of first screws SW1. The rack bar accommodating section 10 is composed of: a first rack bar accommodating part 110 that extends through the inside of the first housing 11 in the axial direction; and a second rack bar accommodating part 120 that is connected to the first rack bar accommodating part 110 and extends through the inside of the second housing 12 in the axial direction (see FIG. 2).

The steering assist mechanism AM includes: an electric motor 4 that generates a steering assist force; a control device 5 that controls driving of the electric motor 4; and a transmission mechanism 6 that transmits a driving force of the electric motor 4 to the rack bar 3. Specifically, the steering assist mechanism AM assists axial movement of the rack bar 3 with the driving force of the electric motor 4 that is driven and controlled by the control device 5 based on sensed information of various sensors such as the torque sensor TS and a vehicle speed sensor not shown. The torque sensor TS is connected to the control device 5 by wire via a harness WH that is arranged to extend along the rack housing 1.

FIG. 2 is an enlarged partial cross-sectional view of the electric power steering device, showing the transmission mechanism 6 and its surroundings.

As shown in FIG. 2, the first housing 11 is integrally formed of a metal material such as an aluminum alloy material. Specifically, the first housing 11 is integrally composed of: the first rack bar accommodating part 110 that has a tubular shape and accommodates the first axial end side of the rack bar 3; a bearing accommodating part 111 that is formed to have a diameter that increases stepwise with respect to the first rack bar accommodating part 110 and accommodates a ball bearing 7 that supports a ball nut 641 described below rotatably; and a motor support part 112 that extends radially outwardly (upwardly in FIG. 2) from the bearing accommodating part 111 and supports the electric motor 4.

The first rack bar accommodating part 110 is formed at a first end side of the first housing 11 so as to extend in the axial direction. The bearing accommodating part 111 is formed to have a diameter that increases stepwise via an end wall 114 from an end portion of the first rack bar accommodating part 110 facing the second housing 12, and has an inner diameter to allow an outer race part 71 of the ball bearing 7 to be inserted in a non-press-fit state.

The electric motor 4 is fastened to a first end of the motor support part 112, i.e., an end opposite to the second housing 12, by a plurality of second screws SW2, so that the electric motor 4 is fixed to the first housing 11 via the second screws SW2. The motor support part 112 also includes a motor receiving hole 112a that extends through generally parallel to the first rack bar accommodating part 110, and receives a tip side journal part 40 of the electric motor 4 in a loose fit state.

The second housing 12 is integrally formed of the same metal material as the first housing 11, for example, an aluminum alloy material, and is fastened to a second end of the first housing 11 via a plurality of first screws SW1 (see FIG. 1) so as to cover the bearing accommodating part 111 and the motor support part 112. Specifically, the second housing 12 is integrally composed of: the second rack bar accommodating part 120 that has a tubular shape and accommodates the second axial end of the rack bar 3; and a transmission mechanism accommodating part 121 that is formed to expand in a stepwise manner from the second rack bar accommodating part 120 and accommodates the transmission mechanism 6.

The second rack bar accommodating part 120 is formed at the second end side of the second housing 12 so as to extend in the axial direction. The transmission mechanism accommodating part 121 is formed to have a bottomed elliptical tubular shape that opens toward the first housing 11 in the axial direction. The transmission mechanism accommodating part 121 is formed at an end (first end) of the second rack bar accommodating section 120 facing the first housing 11, expanding in a stepwise manner. Specifically, the transmission mechanism accommodating part 121 includes: a first pulley accommodating portion 122 that accommodates an input side pulley 61 described below; a second pulley accommodating portion 123 that accommodates an output side pulley 62 described below; and a belt accommodating portion not shown that is arranged across the first pulley accommodating portion 122 and the second pulley accommodating portion 123 and accommodates a belt member 63 described below.

The transmission mechanism 6 includes: a pair of pulleys, namely, the input side pulley 61 and the output side pulley 62; the belt member 63 wound between the input side pulley 61 and the output side pulley 62; and a ball screw mechanism 64 as a reduction mechanism that converts rotation of the output side pulley 62 into axial movement of the rack bar 3 with speed reduction from rotation of the output side pulley 62. The transmission mechanism 6 is only required to be capable of transmitting a rotational force of the electric motor 4 to the ball screw mechanism 64, and may be arbitrarily configured depending on specifications of the embodied electric power steering device. For example, the transmission mechanism 6 may be implemented not only by the combination of the pair of pulleys 61, 62 and the belt member 63 wound between the pulleys 61, 62 as exemplified in this embodiment, but also by a combination of a pair of sprockets and a chain wound between the sprockets.

The input side pulley 61 is formed of a metal material to have a cylindrical shape having a smaller diameter than the output side pulley 62, and is fixed by press-fitting onto an outer periphery of a tip end portion of an output shaft 41 of the electric motor 4 via a through hole 620 that extends in the axial direction radially inside the input side pulley 61. Accordingly, the input side pulley 61 rotates together with the output shaft 41 as an integrated member about a second reference axis A2 that is a rotation axis of the output shaft 41 of the electric motor 4.

The output side pulley 62 is disposed radially outside the rack bar 3 and is linked with the rack bar 3 via the ball screw mechanism 64. Specifically, the output side pulley 62 is made of the same metal material as the input side pulley 61, has a bottomed cylindrical shape having a larger diameter than the input side pulley 61, is fixed to an outer periphery of the ball nut 641 described below, and rotates together with the ball nut 641 as an integrated member around a first reference axis A1 identical to the central axis of the rack bar 3.

The belt member 63 is an endless V-belt in which a core material such as glass fiber or steel wire is embedded. The belt member 63 connects the input side pulley 61 and the output side pulley 62 and causes them to rotate in synchronization with each other, thereby transmitting a rotational force of the input side pulley 61 to the output side pulley 62.

The ball screw mechanism 64 includes: the ball nut 641 having a cylindrical tubular shape and arranged radially outside the rack bar 3; a ball circulation groove 642 formed between the ball nut 641 and the rack bar 3; a plurality of balls 643 rollably disposed within the ball circulation groove 642; and a cylindrical tube 644 that connects both ends of the ball circulation groove 642 and circulates the balls 643.

The ball nut 641 is formed of a metal material to have a tubular shape surrounding the rack bar 3, and is rotatably supported by the first housing 11 via the ball bearing 7, and is structured to rotate with respect to the rack bar 3. The ball circulation groove 642 is composed of: an axis side ball screw groove 642a formed in an outer periphery of the rack bar 3 and having a spiral groove shape; and a nut side ball screw groove 642b formed in an inner periphery of the ball nut 641 and having a spiral groove shape corresponding to the axis side ball screw groove 642a.

The ball bearing 7 includes: the outer race part 71 held in the bearing accommodating part 111 of the first housing 11 via a holder 8; an inner race part 72 arranged to face an inner periphery of the outer race part 71 and formed integrally with the ball nut 641; and a plurality of balls 73 rollably accommodated between the outer race part 71 and the inner race part 72. In this embodiment, the inner race part 72 is formed integrally with the ball nut 641, but the inner race part 72 is not limited to being formed integrally with the ball nut 641, and may be a part formed separately from the ball nut 641 and fixed to the ball nut 641.

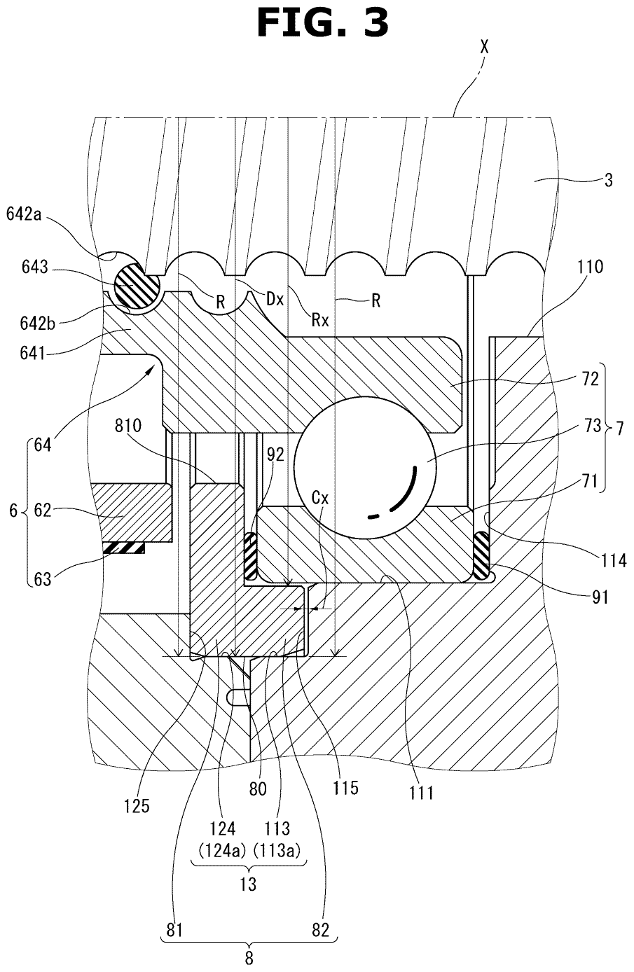

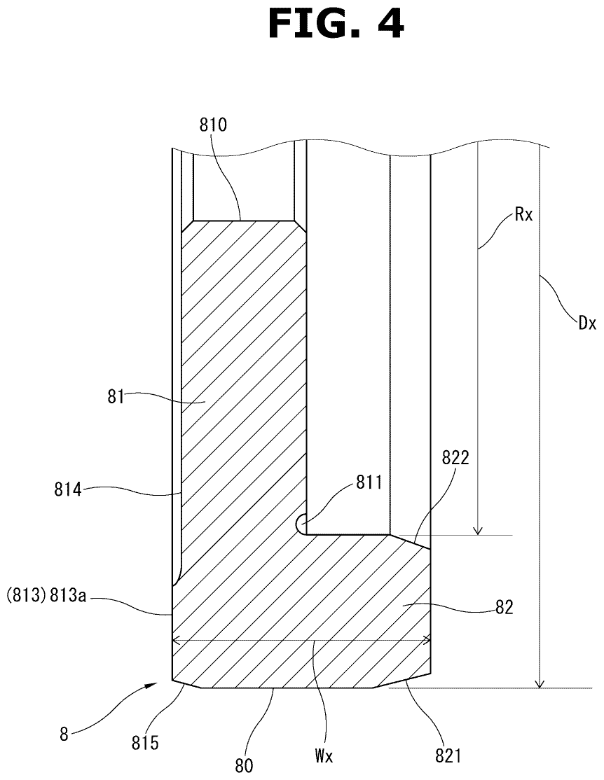

FIG. 3 is an enlarged view of a major part of the electric power steering device, showing the ball bearing 7 and its surroundings, which form the major part of FIG. 2. FIG. 4 shows the holder 8 shown in FIG. 2 alone. FIG. 4 shows an enlarged cross-sectional view of the holder 8, in which the cross section of the holder 8 is enlarged. In the following, for convenience, each part is described wherein a right end of the part in FIGS. 3 and 4 is referred to as a first end, and a left end of the part in FIGS. 3 and 4 is referred to as a second end.

As shown in FIG. 3, the first housing 11 includes: the bearing accommodating part 111 that accommodates the ball bearing 7 at an axial end (second end) of the first housing 11 facing the second housing 12; and a first holder accommodating part 113 formed to have a diameter increasing stepwise from the bearing accommodating part 111 toward the second end side and accommodates a first end side of the holder 8 (a projecting part 82 described below). The end wall 114 is formed at a first end of the bearing accommodating part 111 and extends radially outwardly from the first rack bar accommodating part 110 (see FIG. 2). Furthermore, a first step part 115 is formed between the bearing accommodating part 111 and the first holder accommodating part 113 and extends radially outwardly from the first holder accommodating part 113.

The second housing 12 includes a second holder accommodating part 124 at its axial end (first end) facing the first housing 11. The second holder accommodating part 124 accommodates and holds a second end side (a base part 81 described below) of the holder 8. Furthermore, a second step part 125 is formed between the transmission mechanism accommodating part 121 and the second holder accommodating part 124, extending radially outwardly from the second holder accommodating part 124.

The first holder accommodating part 113 and the second holder accommodating part 124 have the same inner diameter R such that a peripheral wall 113a of the first holder accommodating part 113 and a peripheral wall 124a of the second holder accommodating part 124 cooperate to form a fitting face 13 on which the holder 8 can be fitted. Specifically, the fitting face 13 has an inner diameter R slightly smaller than an outer diameter Dx of the holder 8, allowing the holder 8 to be fitted thereon. In other words, the holder 8 is fitted on the fitting face 13, which is composed of the peripheral wall 113a of the first holder accommodating part 113 and the peripheral wall 124a of the second holder accommodating part 124, thereby forming a so-called spigot joint structure, and making it possible to center the first housing 11 (first rack bar accommodating part 110) and the second housing 12 (second rack bar accommodating part 120) such that the central axis of the first housing 11 and the central axis of the second housing 12 coincide with each other.

Furthermore, an axial distance between the first holder accommodating part 113 and the second holder accommodating part 124, i.e., an axial distance L between the first step part 115 and the second step part 125, is set to be slightly larger than an axial length W of the holder 8 including the base part 81 and the projecting part 82, wherein the holder 8 is accommodated between the first holder accommodating part 113 and the second holder accommodating part 124. In other words, the axial distance L from the first step 115 to the second step 125 is set to allow an axial gap Cx to be formed between the projecting part 82 and the first step 115 when the base part 81 is in contact with the second step 125.

The ball bearing 7 includes: the outer race part 71 held within the bearing accommodating part 111 of the first housing 11 via the holder 8; the inner race part 72 arranged radially inside the outer race part 71 to face the inner periphery of the outer race part 71 in the radial direction; and the plurality of balls 73 rollably accommodated between the outer race part 71 and the inner race part 72. The outer race part 71 is inserted into the bearing accommodating part 111 of the first housing 11 from the second end side. Axial movement of the outer race part 71 toward the first end side is restricted by the end wall 114 of the first housing 11, while axial movement of the outer race part 71 toward the second end side is restricted by the holder 8.

Furthermore, a first elastic member 91 is interposed between the outer race part 71 and the end wall 114 in a state in which the first elastic member 91 generates an elastic force (a pre-loaded state), and a second elastic member 92 is interposed between the outer race part 71 and the holder 8 (the base part 81 described below) in a state in which the second elastic member 92 generates an elastic force (a pre-loaded state). The first elastic member 91 and the second elastic member 92 are identical to each other, and are each made of a wave washer or a disc spring in this example, and each have an outer diameter D slightly smaller than an outer diameter D of the outer race part 71 and have an inner diameter larger than an inner diameter of the outer race part 71. In other words, the first elastic member 91 and the second elastic member 92 are configured such that substantially the entirety of each of the first elastic member 91 and the second elastic member 92 can abut on the corresponding axial end face of the outer race part 71.

As shown in FIGS. 3 and 4, the holder 8 is formed integrally of a metal material to have a generally circular ring shape with an L-shaped cross section. The holder 8 includes: the base part 81 having a generally disc-like shape and arranged to face the outer race part 71 in the axial direction; and the projecting part 82 having a generally cylindrical tubular shape and extending in the axial direction from an end face on the first end side of the base part 81. When the first housing 11 and the second housing 12 are joined together, the base part 81 of the holder 8 is biased toward the second end side by the elastic force of the first elastic member 91 and the elastic force of the second elastic member 92 (mainly the elastic force of the second elastic member 92). In this way, the base part 81 of the holder 8 is biased toward the second end side by the elastic force of the second elastic member 92, and is pressed onto the second step part 125 of the second housing 12. On the other hand, the biasing of the base part 81 toward the second end side by the elastic force of the second elastic member 92 causes the holder 8 to be in a state in which a tip end portion (first end portion) of the projecting part 82 is separated from the first step part 115.

It is desirable that the holder 8 is formed of a metal material (e.g., an aluminum alloy material) having the same linear expansion coefficient as the first housing 11 and the second housing 12. However, the holder 8 may be formed of a metal material having a linear expansion coefficient different from that of the first housing 11 and the second housing 12. In such a case where the holder 8 is formed of a metal material having a linear expansion coefficient different from that of the first housing 11 and the second housing 12, a difference in expansion occurs between the holder 8 and the first and second housings 11, 12 due to a difference in linear expansion coefficient between the holder 8 and the first and second housings 11, 12, wherein the difference in expansion is absorbed mainly by the elastic force of the second elastic member 92.

As shown in FIGS. 3 and 4, the base part 81 has a disc shape having a generally uniform thickness (axial width) and has a central portion including a through hole 810 through which the ball nut 641, which is formed integrally with the inner race part 72, passes. The through hole 810 is set to have an inner diameter that is sufficiently larger than an outer diameter of the ball nut 641. As shown in FIG. 4, a corner formed at a boundary between the base part 81 and the projecting part 82 has a groove 811 recessed away from the second elastic member 92 (toward the second end side) in the axial direction. The groove 811 is located in a region radially outside the second elastic member 92 and has an opening facing the second elastic member 92 (toward the first end side), and is formed to have a continuous annular shape extending in the circumferential direction. In other words, the formation of the groove 811 serves to remove a rounded corner portion not shown that is formed at the boundary between the base part 81 and the projecting part 82 during manufacturing. The second elastic member 92 is disposed so as to abut on a flat surface 812 radially inside the groove 811.

As shown in FIG. 4, the base part 81 includes an end face facing the second step 125 (on the second end side) where a protrusion 813 is formed by slightly protruding a portion facing the second step 125. The protrusion 813 protrudes slightly toward the second end side with respect to a general portion 814 radially inside the protrusion 813, wherein the base portion 814 is out of contact with the second housing 12. The protrusion 813 has a continuous annular shape extending in the circumferential direction. Almost the entire protrusion 813 abuts on the second step part 125. The protrusion 813 is not required to be formed annularly, but may be composed of a plurality of separate pieces arranged in the circumferential direction. Furthermore, the protrusion 813 has a contact face 813a in contact with the second step part 125, wherein the contact face 813a is precisely finished by machining or the like, in contrast to the general portion 814 that is not processed. In other words, in this embodiment, only the contact surface 813a of the protrusion 813 in contact with the second step 125 is precisely finished by machining or the like.

As shown in FIG. 4, the second end side of the base part 81, which is inserted into the second holder accommodating part 124, has an outer periphery formed with a base side tapered portion 815. The base part side tapered portion 815 has an outer diameter Dx that gradually decreases toward the second end side. Thereby, when the base part 81 is inserted into the second holder accommodating part 124, the base side taper portion 815 serves to guide the fitting between the base part 81 and the second holder accommodating part 124, and thereby ensure smooth assembly of the second housing 12 to the first housing 11.

As shown in FIG. 3, the projecting part 82 is formed to have a tubular shape extending in the circumferential direction radially outside the outer periphery of the base part 81. The projecting part 82 has an axial length Wx (see FIG. 4) so as to surround the outer periphery of the outer race part 71 and the outer periphery of the second elastic member 92 while overlapping with the outer race part 71 and the second elastic member 92 as viewed in the radial direction. This configuration allows the second elastic member 92 to be assembled to the holder 8 integrally by covering the outer race part 71 of the ball bearing 7 by the holder 8 with the second elastic member 92 held by the holder 8. Furthermore, the projecting part 82 has an inner diameter Rx that is slightly larger than the outer diameter D of the outer race part 71, allowing a radial gap Cr to be formed between the outer race part 71 and the projecting part 82.

As shown in FIG. 3, the projecting part 82 is formed so as to be continuous with the base part 81 without any step at the outer periphery, so that the holder 8 has a continuous flat fitting surface 80 spanning the base part 81 and the projecting part 82. The outer diameter Dx of this fitting surface 80 is set to an arbitrary outer diameter that allows the fitting face 80 to be fitted with the fitting face 13 spanning the first housing 11 and the second housing 12. In this embodiment, the outer diameter Dx of the fitting surface 80 is set to allow a clearance fit with the fitted surface 13 of the first housing 11 and the second housing 12.

As shown in FIG. 4, the first end side of the projecting part 82, which is inserted into the first holder accommodating part 113, has an outer periphery formed with a first projecting part side tapered portion 821. The first projecting part side tapered portion 821 has an outer diameter Dx that gradually decreases toward the first end side. Thereby, when the projecting part 82 is inserted into the first holder accommodating part 113, the first projecting part side tapered portion 821 serves to guide the fitting between the projecting part 82 and the first holder accommodating part 113, and thereby ensure smooth assembly of the holder 8 to the first housing 11.

Furthermore, as shown in FIG. 4, the first end side of the projecting part 82, which surrounds the outer race part 71, has an inner periphery formed with a second projecting part side tapered portion 822. The second projecting part side tapered portion 822 has an inner diameter Rx that gradually increases toward the first end side. Thereby, when the projecting part 82 is inserted into the first holder accommodating part 113, the second projecting part side tapered portion 822 serves to guide the insertion of the projecting part 82 into the outer race part 71, and thereby ensure smooth assembly of the holder 8 to the first housing 11.

<Operation and Effects of Present Embodiment>The configuration of the conventional electric power steering device that the bearing 7 is fastened to the housing 1 by the lock nut may cause galling of the lock nut with respect to the housing 1. Furthermore, if the lock nut is made of a material different from that of the housing 1, the lock nut may be loosened due to heat. In view of the foregoing, there has been room for improvement.

In contrast, the electric power steering device according to the present embodiment is capable of producing advantageous effects as described below and thereby solving the problems with the conventional electric power steering device.

According to the present embodiment, an electric power steering device includes: a rack bar 3 linked with a steering shaft 2; a transmission mechanism 6 structured to transmit a steering assist force to the rack bar 3, wherein the steering assist force is generated by an electric motor 4; a first housing 11 accommodating the rack bar 3; a second housing 12 accommodating the transmission mechanism 6 and coupled with the first housing 11 such that the second housing 12 faces the first housing 11 in an axial direction of the rack bar 3; a ball screw mechanism 64 disposed radially outside the rack bar 3; a ball bearing 7 structured to support a rotation part (ball nut 641) of the ball screw mechanism 64 rotatably with respect to the first housing 11; a holder 8 structured to hold the ball bearing 7 such that the ball bearing 7 is sandwiched between the holder 8 and the first housing 11, wherein the holder 8 has an axial end face in contact with the second housing 12, and wherein the axial end face faces away from the ball bearing 7; and an elastic member (first elastic member 91, second elastic member 92) disposed between the ball bearing 7 and the holder 8 or between the ball bearing 7 and the first housing 11 in the axial direction of the rack bar 3.

In this embodiment, the ball bearing 7 is thus held by the holder 8 whose axial movement is restricted by the second housing 12. Since the holder 8 is not screwed to the housing, there is no possibility of loosening due to galling or thermal expansion. Furthermore, if thermal expansion occurs in the holder 8, the thermal expansion is absorbed by the first elastic member 91 or the second elastic member 92. Accordingly, there is also no possibility that the ability of the holder 8 for holding the ball bearing 7 is adversely affected by the thermal expansion.

Furthermore, according to the present embodiment, the electric power steering device includes two of the elastic members including a first one disposed between the ball bearing 7 and the holder 8 in the axial direction of the rack bar 3 and a second one disposed between the ball bearing 7 and the first housing 11 in the axial direction of the rack bar 3.

In this way, in this embodiment, the first elastic member 91 is arranged between the ball bearing 7 and the first housing 11, and the second elastic member 92 is arranged between the ball bearing 7 and the holder 8. Namely, both axial sides of the ball bearing 7 (outer race part 71) are provided with the respective elastic members. With this configuration, the outer race part 71 of the ball bearing 7 is biased from both sides in the axial direction, making it possible to reduce a difference in steering feel between left and right directions of steering.

Furthermore, according to the present embodiment, the holder 8 includes a portion radially outside the ball bearing 7 at which portion the holder 8 is positioned with respect to the second housing 12.

If the holder 8 is positioned at the axial end of the ball bearing 7, the holder 8 may interfere with the transmission mechanism 6. In order to avoid such interference, the housing 1 may be upsized in the axial direction. In contrast, in this embodiment, the holder 8 includes a portion radially outside the ball bearing 7 at which portion the holder 8 is positioned with respect to the second housing 12. This serves to prevent interference between the holder 8 and the transmission mechanism 6, and allow the housing 1 to be downsized in the axial direction.

Furthermore, according to the present embodiment, the elastic member (second elastic member 92) is disposed between the ball bearing 7 and the holder 8 in the axial direction of the rack bar 3; and the holder 8 includes a projecting part 82 that projects toward the ball bearing 7 in the axial direction of the rack bar 3 and surrounds the elastic member (second elastic member 92).

In this way, in this embodiment, the holder 8 includes the projecting part 82 that projects toward the ball bearing 7 in the axial direction of the rack bar 3 and surrounds the second elastic member 92. This allows the projecting part 82 of the holder 8 to prevent the second elastic member 92 from being detached. The prevention of detachment of the second elastic member 92 by the projecting part 82 is effective not only after assembling of the second elastic member 92, but also during assembling of the second elastic member 92.

Furthermore, according to the present embodiment, the holder 8 includes a corner portion at a boundary of the projecting part 82, wherein the corner portion includes a groove 811 that extends away from the elastic member (second elastic member 92) in the axial direction of the rack bar 3.

Thus, in this embodiment, the holder 8 includes the corner portion at the boundary of the projecting part 82, wherein the corner portion includes the groove 811 that extends away from the second elastic member 92 in the axial direction of the rack bar 3. In other words, the formation of the groove 811 serves to remove a rounded corner portion not shown that is formed at the boundary between the base part 81 and the projecting part 82 during manufacturing. Accordingly, the formation of the groove 811 serves to prevent the second elastic member 92 from being raised and detached at the boundary or rounded corner portion between the base part 81 and the projecting part 82 in the holder 8, and thereby allow the second elastic member 92 to be positioned suitably.

For preventing the second elastic member 92 from being raised by the rounded corner portion, it may be conceivable to form the groove 811 to be recessed outwardly in the radial direction of the rack bar 3 from the inner periphery of the projecting part 82. However, this configuration is unsuitable, because when the second elastic member 92 moves in the radial direction, the second elastic member 92 may get stuck in the groove 811, and thereby fail to perform its suitable elastic function.

Furthermore, according to the present embodiment, the holder 8 has an outer peripheral surface fitted with the first housing 11 or the second housing 12.

Thus, in this embodiment, the holder 8 has the outer peripheral surface (fitting face 80) fitted with the first housing 11 (the peripheral wall 113a of the first holder accommodating part 113) or the second housing 12 (the peripheral wall 124a of the second holder accommodating part 124). Accordingly, the first housing 11 and the second housing 12 can be centered by the holder 8 that is fitted with the first housing 11 or the second housing 12. This allows the electric power steering device to be suitably attached to the vehicle body via vehicle body suspension parts (brackets BKT) provided in the housings 11, 12.

Furthermore, according to the present embodiment, the holder 8 includes a projecting part 82 facing the ball bearing 7 in the axial direction of the rack bar 3; and the projecting part 82 has an inner diameter Rx larger than an outer diameter D of the ball bearing 7.

According to the present invention, the inner diameter Rx of the projecting part 82 is set larger than the outer diameter D of the outer race part 71 of the ball bearing 7 such that the radial gap Cr is formed between the projecting part 82 and the ball bearing 7. Accordingly, there is no possibility that movement of the ball bearing 7 in the axial direction of the rack bar 3 during steering is hindered by the holder 8. This serves to ensure smooth steering and preferable steering feeling.

Furthermore, according to the present embodiment, the holder 8 includes a projecting part 82 facing the ball bearing 7 in the axial direction of the rack bar 3; the projecting part 82 has a tapered portion (first projecting part side tapered portion 821) at an end of the projecting part 82 in the axial direction of the rack bar 3; and the tapered portion (first projecting part side tapered portion 821) has an outer diameter Dx that decreases toward the end of the projecting part 82.

Thus, in this embodiment, the projecting part 82 of the holder 8 has the first projecting part side tapered portion 821 at the end (first end) of the projecting part 82 in the axial direction of the rack bar 3, and the first projecting part side tapered portion 821 has the outer diameter Dx that decreases toward the end of the projecting part 82. The first projecting part side tapered portion 821 serves to guide insertion of the holder 8 into the first holder accommodating part 113 during assembling of the holder 8. This serves to improve the ease of assembling the holder 8.

Furthermore, according to the present embodiment, the holder 8 includes a part that protrudes toward the second housing 12 and is in contact with the second housing 12.

In order to suitably join the first housing 11 and the second housing 12, the contact surface of the holder 8 with the second housing 12 (second step part 125) is required to be finished with precision. Therefore, if the entire surface of the holder 8 facing the second housing (second step part 125) is formed flat, the entire surface of the holder 8 is required to be finished with precision. In contrast, in the present embodiment, the provision of the protrusion 813 that is formed by partially protruding only a portion of the holder 8 for contact with the second housing (second step part 125), results in that it is only required to precisely finish the end face of the protrusion 813. This serves to improve productivity of the electric power steering device and reduce its manufacturing cost.

Furthermore, according to the present embodiment, the holder 8 is in contact with the second housing 12 and out of contact with the first housing 11, wherein the first housing 11 and the second housing 12 are coupled with each other.

In this way, in this embodiment, the holder 8 is structured to be in contact with the second housing 12 and out of contact with the first housing 11, wherein the first housing 11 and the second housing 12 are coupled with each other. This serves to prevent a gap from occurring between the first housing 11 and the second housing 12 depending on accuracy (manufacturing error, etc.) of the holder 8 interposed between the first housing 11 and the second housing 12. This serves to prevent foreign matter from entering the housing 1 through the gap between the first housing 11 and the second housing 12.

The present invention is not limited to the configuration of the embodiment described above. The configuration may be arbitrarily modified depending on specifications of an electric power steering device to which the present invention is applied, if the modified configuration is still capable of achieving the actions and advantageous effects of the present invention.

In particular, the projecting part 82 is not essential for the holder 8. Although specific illustration is omitted, both axial ends of the holder 8 on the first end side and the second end side may be provided with the respective projecting parts 82, wherein the projecting part 82 arranged on the second end side may be set in contact with the second housing (second step part 125).

Furthermore, the first elastic member 91 and the second elastic member 92, which correspond to the elastic members according to the present invention, are not necessarily required to be arranged at respective axial ends of the outer race part 71 of the ball bearing 7. Only one of the axial ends of the outer race part 71 may be provided with the elastic member for biasing the holder 8 toward the second housing (second step part 125).

Furthermore, the bearing according to the present invention is not limited to the ball bearing 7 disclosed in the present embodiment. The bearing may be any bearing capable of supporting rotation of the ball nut 641, and may be arbitrarily modified depending on specifications, etc., of an electric power steering device to which the present invention is applied.

1.-10. (canceled)

11. An electric power steering device comprising:
a rack shaft linked with a steering shaft;
a transmission mechanism structured to transmit a steering assist force to the rack shaft, wherein the steering assist force is generated by an electric motor;
a first housing accommodating the rack shaft;
a second housing accommodating the transmission mechanism and coupled with the first housing such that the second housing faces the first housing in an axial direction of the rack shaft;
a ball screw mechanism disposed radially outside the rack shaft;
a bearing structured to support a rotation part of the ball screw mechanism rotatably with respect to the first housing;
a holder structured to hold the bearing such that the bearing is sandwiched between the holder and the first housing, wherein the holder has an axial end face in contact with the second housing, and wherein the axial end face faces away from the bearing; and
an elastic member disposed between the bearing and the holder or between the bearing and the first housing in the axial direction of the rack shaft;
wherein the holder includes a portion radially outside the bearing at which portion the holder is positioned with respect to the second housing.

12. The electric power steering device as claimed in claim 11, comprising two of the elastic members including a first one disposed between the bearing and the holder in the axial direction of the rack shaft and a second one disposed between the bearing and the first housing in the axial direction of the rack shaft.

13. The electric power steering device as claimed in claim 11, wherein:
the elastic member is disposed between the bearing and the holder in the axial direction of the rack shaft; and
the holder includes a projecting part that projects toward the bearing in the axial direction of the rack shaft and surrounds the elastic member.

14. The electric power steering device as claimed in claim 13, wherein the holder includes a corner portion at a boundary of the projecting part, wherein the corner portion includes a groove that extends away from the elastic member in the axial direction of the rack shaft.

15. The electric power steering device as claimed in claim 11, wherein the holder has an outer peripheral surface fitted with the first housing or the second housing.

16. The electric power steering device as claimed in claim 11, wherein:
the holder includes a projecting part facing the bearing in the axial direction of the rack shaft; and
the projecting part has an inner diameter larger than an outer diameter of the bearing.

17. The electric power steering device as claimed in claim 11, wherein:
the holder includes a projecting part facing the bearing in the axial direction of the rack shaft;
the projecting part has a tapered portion at an end of the projecting part in the axial direction of the rack shaft; and
the tapered portion has an outer diameter that decreases toward the end of the projecting part.

18. An electric power steering device comprising:
a rack shaft linked with a steering shaft;
a transmission mechanism structured to transmit a steering assist force to the rack shaft, wherein the steering assist force is generated by an electric motor;
a first housing accommodating the rack shaft;
a second housing accommodating the transmission mechanism and coupled with the first housing such that the second housing faces the first housing in an axial direction of the rack shaft;
a ball screw mechanism disposed radially outside the rack shaft;
a bearing structured to support a rotation part of the ball screw mechanism rotatably with respect to the first housing;
a holder structured to hold the bearing such that the bearing is sandwiched between the holder and the first housing, wherein the holder has an axial end face in contact with the second housing, and wherein the axial end face faces away from the bearing; and
an elastic member disposed between the bearing and the holder or between the bearing and the first housing in the axial direction of the rack shaft;
wherein the holder includes a part that protrudes toward the second housing and is in contact with the second housing.

19. The electric power steering device as claimed in claim 11, wherein the holder is in contact with the second housing and out of contact with the first housing, wherein the first housing and the second housing are coupled with each other.
